(19) United States
(12) Patent Application Publication
(10) Pub. No.: US 2026/0286721 A1
(43) Pub. Date: Sep. 24, 2026

(54) CONCRETE FORMING TOOL

(71) Applicant: Bull Force Concrete Products LLC, Sioux Center, IA (US)

(72) Inventors: Greg Schut, Sioux Center, IA (US); Alec Korver, Monument, CO (US)

(21) Appl. No.: 19/573,254

(22) Filed: Mar. 20, 2026

Related U.S. Application Data
(60) Provisional application No. 63/776,529, filed on Mar. 24, 2025.

(51) Int. Cl. E04F 21/24; B25H 1/00; E01C 19/44; G01C 9/02; H02J 50/10

(52) U.S. Cl. CPC E04F 21/241; B25H 1/0085; E01C 19/44; G01C 9/02; H02J 50/10

(57) ABSTRACT

A concrete forming tool including a handle body, an orientation sensor, an electronic display, and a processor. The handle body is to be attached to a tool body. The orientation sensor is disposed in the handle body and configured to output orientation data. The electronic display is attached to the handle body. The processor operatively coupled to the orientation sensor and the electronic display. The processor is configured to determine an angle of the tool body relative to a reference plane based at least in part on the orientation data. The processor is configured to present angle information pertaining to the angle via the electronic display.

### CROSS REFERENCE TO RELATED APPLICATIONS

This application claims the benefit of U.S. Provisional Application No. 63/776,529, filed Mar. 24, 2025, and is incorporated herein by reference in its entirety.

### FIELD

This disclosure relates to tools and, in particular, to concrete finishing tools.

### BACKGROUND

Many concrete flatwork projects include finishing concrete to have a slope, for example, to direct waterflow. For example, concrete driveways and patios typically slope away from a building to avoid water pooling on the concrete (e.g., when it rains) and/or flowing toward the building. Moreover, many concrete projects (e.g., parking lots, streets) include a slope or sloped portions to direct waterflow to a drain. In many projects, the engineering drawings specify the slope of the concrete at various locations of the project. For example, the engineering drawings may specify a sidewalk have a particular slope (e.g., 2%) that complies with ADA standards.

When pouring concrete, forming the concrete to have a desired slope can be difficult and time consuming. In current approaches, when finishing a concrete surface to have a desired slope, a concrete worker repeatedly checks the concrete with one tool to determine the slope of the surface and then continues to work the concrete with another tool (e.g., by removing or adding concrete) until the desired slope is achieved. For example, the concrete worker may measure the height of the concrete at various locations with a tape measure or laser to estimate a change in height of the concrete surface over a length. As another example, a concrete worker may use a level to check whether the concrete has the desired slope. Finishing a sloped concrete surface thus takes time as the concrete worker repeatedly measures the slope to guide how to work the concrete to achieve the desired slope.

### BRIEF DESCRIPTION OF THE DRAWINGS

FIG. 1A is a perspective view of a hand float having an electronic handle to measure and display slope.

FIG. 1B is a perspective view of the hand float of FIG. 1A illustrating the handle detached from a float blade of the hand float.

FIG. 2A is a perspective view of the electronic handle of the hand float of FIG. 1A.

FIG. 2B illustrates an example user interface of the electronic handle of FIG. 2A, the user interface including an electronic display.

FIG. 3 is a block diagram of the electronic handle of FIG. 1A.

FIG. 4 is a flow diagram of a method of measuring an orientation of the electronic handle of FIG. 1A.

FIG. 5 illustrates that the handle of FIG. 3A is attachable to float blades of various sizes.

FIG. 6 is a side view of a screed including the electronic handle of FIG. 3A.

FIG. 7A is a top perspective view of a hand float according to another embodiment having an electronic handle, the electronic handle having a magnetic quick-attach mechanism.

FIG. 7B is a perspective view showing the electronic handle of the hand float of FIG. 7A separated from a float blade of the hand float.

FIG. 8 is a side perspective view of the hand float of FIG. 7A.

FIG. 9 is a cross-section view of the hand float of FIG. 7A.

FIG. 10A is a top perspective view of a hand float according to another embodiment having an electronic handle, the electronic handle of the hand float having a mechanical quick-attach mechanism shown in a locked configuration.

FIG. 10B is a top view of the hand float of FIG. 10A with the mechanical quick-attach mechanism in the locked configuration.

FIG. 10C is a cross-sectional view of the hand float of FIG. 10A taken along lines 10C-10C of FIG. 10B showing the mechanical quick-attach mechanism in the locked configuration

FIG. 11A is a top view of the hand float of FIG. 10A with the mechanical quick-attach mechanism in an unlocked configuration.

11B is a cross-sectional view of the hand float of FIG. 10A taken along lines 11B-11B of FIG. 11A showing the mechanical quick-attach mechanism in the unlocked configuration

FIG. 12 is a side view of a hand float according to another embodiment having an electronic handle, the hand float including adapters secured to the float blade by which the electronic handle is removably attachable to the float blade, the electronic handle shown disconnected from the adapters.

FIG. 13 is a top perspective view of an electronic handle of a hand float according to another embodiment.

FIG. 14 is an exploded view of the electronic handle of FIG. 13.

FIG. 15 is a perspective view of the electronic handle of FIG. 13 with a cover removed.

FIG. 16 is a cross-sectional view of the electronic handle of FIG. 13 taken along lines 16-16 of FIG. 13.

FIG. 17 is a perspective view of two orientation sensors of a circuit board of the electronic handle of FIG. 13.

### DETAILED DESCRIPTION

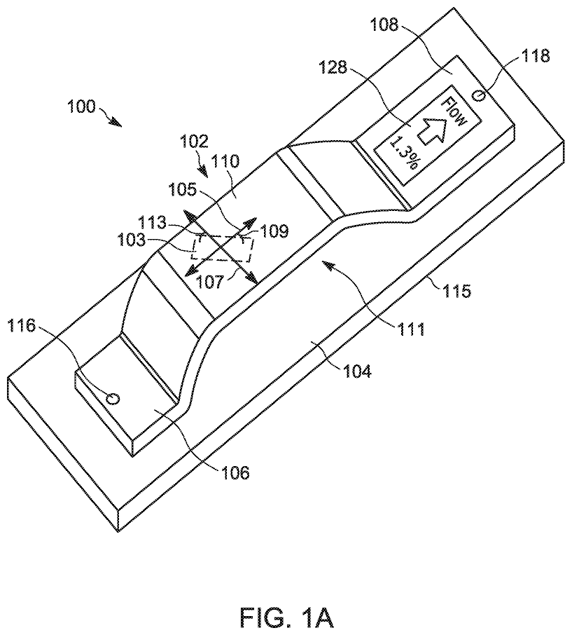

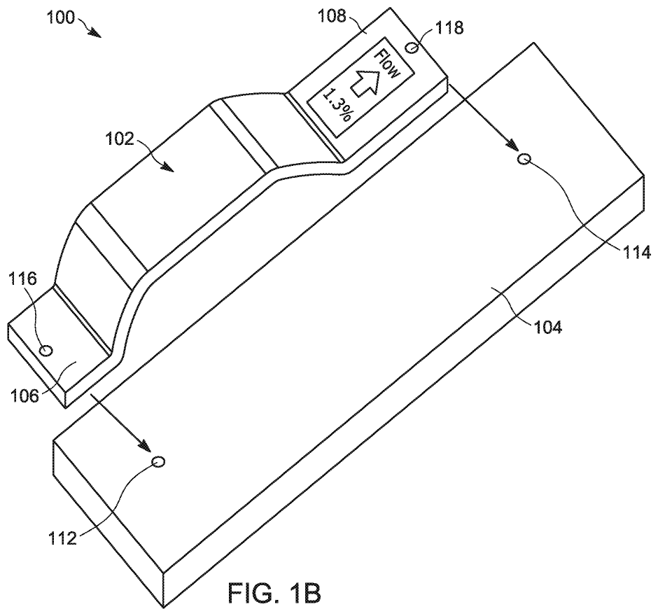

With respect to FIG. 1A, a hand float 100 is shown having a smart handle such as electronic handle 102 and a float blade 104. The electronic handle 102 includes a first attachment portion 106 and a second attachment portion 108 to secure the electronic handle 102 to the float blade 104. The electronic handle 102 includes a grasping portion 110 between the first attachment portion 106 and second attachment portion 108. The grasping portion 110 is spaced from the float blade 104 to form a gap 111 therebetween. For example, the electronic handle 102 may have an arch shape from the first attachment portion 106 to the second attachment portion 108 to space the grasping portion 110 from the first and second attachment portions 106, 108 and a longitudinal axis of the float blade 104. The user may hold the grasping portion 110 when using the hand float 100 to work concrete. For example, the user's fingers may extend in the gap 111 between the grasping portion 110 and the float blade 104. The float blade 104 may be a magnesium float.

The electronic handle 102 measures and displays an angle (e.g., a slope) of the electronic handle 102 relative to a reference plane 103 such as a horizontal plane (e.g., a plane perpendicular to a direction of the force of gravity). The electronic handle 102 includes a longitudinal axis 105 and a lateral axis 107. The electronic handle 102 may measure a pitch angle 109 of the longitudinal axis relative to the reference plane 103 and/or a roll angle 113 of the lateral axis relative to the reference plane 103. The electronic handle 102 may present information pertaining to one or both of the pitch angle 109 and roll angle 113 to the user via a display 136 as discussed in further detail below. The first and second attachment portions 106, 108 may be configured to secure the electronic handle 102 to the float blade 104 (or other tool) such that the longitudinal axis 105 and lateral axis 107 are parallel to a concrete engagement surface 115 of the float blade 104. So configured, the angle of the electronic handle 102 is the same as the angle of the concrete engagement surface 115 and thus the surface of the concrete on which the concrete engagement surface 115 is placed.

With respect to FIG. 1B, the electronic handle 102 may be removably attached to the float blade 104. For example, the electronic handle 102 may be removably fastened to the float blade 104 such that the electronic handle 102 can be removed, for example, to be used with a float blade of another size, as discussed below. As another example, the electronic handle 102 may be retrofit to a conventional hand float by replacing the conventional handle with the electronic handle 102. The float blade 104 may include attachment openings 112, 114. The first attachment portion 106 may include an opening 116 corresponding to the attachment opening 112 of the float blade 104 and the second attachment portion 108 may include an opening 118 corresponding to the attachment opening 114 of the float blade 104. The spacing between the openings 116, 118 may be sized to align with the attachment openings 112, 114 of the float blade 104. For example, the distance between the openings 116, 118 may be sized to align with the openings of conventional float blades (e.g., a distance 6.75 inches used in many hand floats) to permit the electronic handle 102 to be retrofit to a conventional hand float. A fastener may be extended into the opening 116 of the first attachment portion 106 and the attachment opening 112 and a fastener may be extended into the opening 118 of the second attachment portion 108 and the attachment opening 114 to secure the electronic handle 102 to the float blade 104. The fasteners may be withdrawn to detach the electronic handle 102 from the float blade 104.

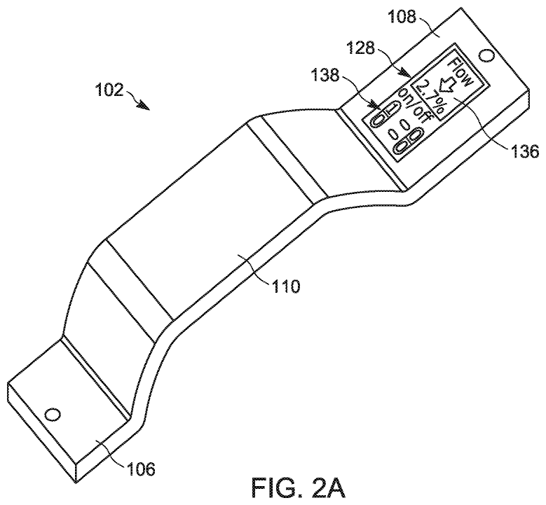

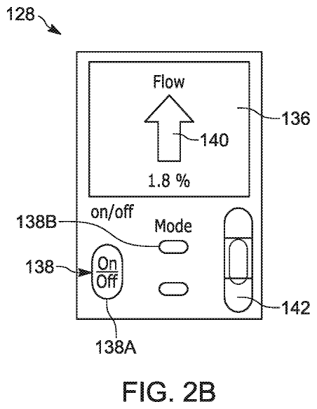

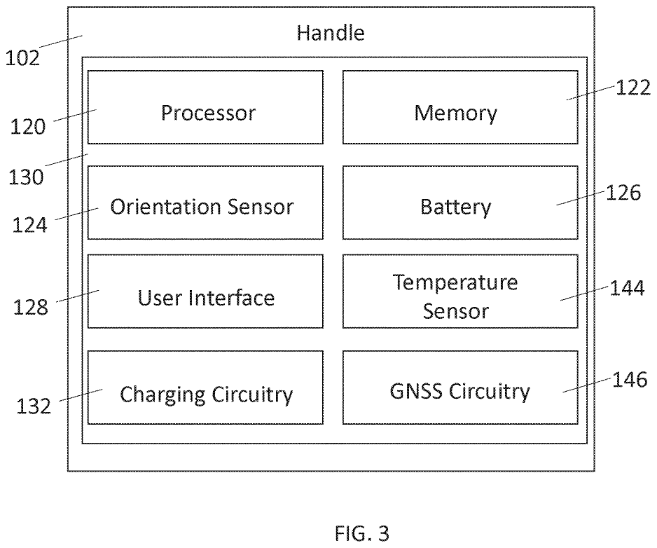

With reference also to FIGS. 2A-3, the electronic handle 102 includes a processor 120, memory 122, an orientation sensor 124, battery 126, and a user interface 128. The electronic handle 102 may include a watertight compartment 130 housing the electrical components of the electronic handle 102. Housing the electrical components of the electronic handle 102 in the watertight compartment 130 shields the electrical components from water and debris (e.g., dirt, cement particles) that come into contact with the electronic handle 102, for example, during use of the hand float 100.

The processor 120 is in communication with memory 122. The processor 120 may execute programs and functions stored in the memory 122 to control operations of the electronic handle 102, such as the operations discussed below. The processor 120 may include, as examples, a microprocessor, an application-specific integrated circuit (ASIC), or a field programmable gate array (FPGA). The memory 122 may include, as examples, an electrical charge-based storage media such as EEPROM or RAM, ROM, or other non-transitory computer readable media such as a flash memory device or magnetic or optical storage medium. The processor 120 and memory 122 are shown schematically as separate components, but it will be appreciated that various embodiments of the processor 120 may include the memory 122 to facilitate the processor 120 performing operations as discussed herein. For example, the processor 120 may include an integrated circuit board having one or more microprocessors and one or memory devices such as RAM and/or ROM. The one or more memory devices store software (e.g., computer code) that, when executed by the one or more microprocessors, perform operations as set forth herein.

The orientation sensor 124 outputs data indicative of the orientation of the electronic handle 102, for example, data to determine the orientation of the electronic handle 102 relative to the reference plane 103 (e.g., a horizontal plane). The orientation sensor 124 may include an inertial measurement unit (IMU). As one example, the IMU is a six axis IMU, having a three-axis accelerometer and a three-axis gyroscope. In some forms, accelerometer and gyroscope of the orientation sensor are on separate computer chips. The IMU may be mounted in the handle with one or more axes of the IMU (e.g., X-axis, Y-axis, or Z-axis) parallel to the longitudinal axis 105 and/or lateral axis 107 of the electronic handle 102. The accelerometer may be used to measure the pitch and roll of the electronic handle 102 by measuring the gravity vector. The gyroscope can be used to measure the pitch and roll of the electronic handle 102 by detecting a rate of rotation relative to the pitch and roll axes (e.g., the longitudinal axis 105 and lateral axis 107). The processor 120 is in communication with the orientation sensor 124 and receives the sensor data output by the orientation sensor 124. The processor 120 uses the data of the orientation sensor 124 to determine the orientation of the electronic handle 102 relative to the earth, for example, relative to a reference plane 103 that is horizontal and perpendicular to the direction of gravity. In some forms, the processor 120 is configured to determine the pitch angle 109 of the longitudinal axis 105 of the electronic handle 102, e.g., relative to the horizontal.

Additionally or alternatively, the processor 120 is configured to determine the roll angle 113 of the lateral axis 107 of the electronic handle 102, e.g., relative to the horizontal. The processor 120 may execute a computer program stored in the memory 122 to process the sensor data of the orientation sensor 124 as discussed below.

The battery 126 of the electronic handle 102 provides electrical power to the electrical components of the electronic handle 102, for example, to the processor 120, orientation sensor 124, and/or user interface 128. As one example, the battery 126 may be a lithium battery. The electronic handle 102 includes charging circuitry 132 to receive electrical power from an external electrical power source (e.g., a battery charger) and to charge the battery 126. In one embodiment, the charging circuitry 132 includes wireless charging circuitry disposed inside the watertight compartment 130. The wireless charging circuitry may include a secondary coil to be aligned with a primary coil of a battery charger to receive electrical power to charge the battery 126. Use of wireless charging circuitry may permit the watertight compartment 130 to be closed without any ports (or reducing the number of ports) therethrough. Reducing or eliminating the number of openings and/or ports through the watertight compartment 130 reduces or eliminates places where water or debris could enter the watertight compartment 130, thus aiding to shield the electrical components therein.

In another embodiment, the charging circuitry 132 of the electronic handle 102 includes a charging port into which a plug of a battery charger may be inserted to charge the battery 126. The charging port may be external to the watertight compartment and include conductors extending from the charging port into the watertight compartment housing the battery 126 to charge the battery 126. The charging port may be mounted on a surface of the first attachment portion 106 or second attachment portion 108 facing the float blade 104 to shield the charging port from water and debris. The electronic handle 102 may be disconnected from the float blade 104 for charging.

In another embodiment, the electronic handle 102 includes a first electrode and a second electrode exposed on an outer surface of the handle to be connected to corresponding electrodes of a battery charger. The conductors may extend from electrodes of the electronic handle 102 into the watertight compartment 130 to provide electrical power to charging circuitry 132 in the watertight compartment 130 and/or the battery 126. Use of such electrodes provides a surface that is easier to wipe down and clean (e.g., after use of the hand float to work concrete). The electrodes may be flush with the outer surface of the electronic handle 102 to minimize the buildup of concrete on the handle about the electrode and to make it easier to wipe down and clean off.

The processor 120 is in communication with the user interface 128. The user interface 128 includes an electronic display 136 and/or one or more inputs such as buttons 138. The electronic display 136 may be, as examples, an LED display, an LCD display, and/or an e-paper display. In some forms, the electronic display 136 is a touchscreen display. The buttons 138 may be physical buttons or virtual buttons on the electronic display.

The processor 120 may present information to the user via the electronic display 136. For example, the processor 120 may present data indicative of the angle of the electronic handle 102 relative to the reference plane 103 (e.g., a horizontal plane) determined from the sensor data of the orientation sensor 124. In one embodiment, the processor 120 may present information of an attitude angle of the electronic handle 102 on the electronic display 136, such as the pitch angle 109 and/or roll angle 113 of the electronic handle 102 relative to the horizontal plane (e.g., 0 to 90 degrees). In one embodiment, the processor 120 may present a slope of the longitudinal axis 105 and/or lateral axis 107 of the electronic handle 102 on the electronic display 136, the slope being the vertical rise divided by the horizontal run. The processor 120 may present the slope in a percent form which may be, for example, the vertical rise divided by the horizontal run and multiplied by 100. The processor 120 may also provide an indication 140 (see FIG. 2B) of the direction of the slope on the electronic display 136, for example, an arrow indicating the direction water would flow down the slope. Including an indication of the direction of slope is advantageous when working with small slopes (e.g., less than 3% slope) as the direction of the slope is not always apparent to the eye. In concrete projects, the direction of the slope is important (e.g., for directing water flow) and sloping the concrete the wrong way can result in undesired water puddling and/or water flow in the wrong direction. In some projects, improper sloping of the concrete can result in having to tear out and repour the concrete at the desired slope.

The processor 120 is in communication with the buttons 138 (see FIG. 2B) to receive input from the user. The buttons 138 of the user interface 128 may include a button 138A to turn the electronic handle 102 on or off. The buttons 138 may include a button 138B to change a mode of the electronic handle 102. For example, the user may press the mode button to change the information presented on the electronic display 136. For example, the user may press the mode button to change the format of the measured angled displayed, e.g., between angle (e.g., in degrees), slope, or percent slope. As another example, the user may press the mode button to change the direction of the attitude angle being measured, for example, to cause the electronic handle 102 to measure and/or display the pitch angle 109, the roll angle 113, or both. In one embodiment, the buttons 138 may be used to set the reference plane 103. For example, the user may orient the electronic handle 102 to the desired orientation and press a button 138 to “tare” the electronic handle 102 to that orientation, for example, to set the reference plane 103 at that current orientation. The electronic display 136 may then display angles measures relative to the set reference plane 103.

The user interface 128 may also include a mechanical bubble level 142. The mechanical bubble level 142 may provide the user with an indication of the direction and degree of the slope. For example, the user can view the bubble level 142 to determine whether a surface is level or sloped without having to turn the electronic handle 102 on. As another example, the user can view the slope presented on the electronic display 136 and refer to the bubble level 142 to determine the direction of the slope. Including the bubble level 142 enables the hand float 100 to be used as a level. For example, the user is able to see if the surface on which the hand float rests is level without having to use a separate tool, such as a traditional level. This is particularly advantageous when forming concrete because the user does not have to place a separate tool (e.g., a conventional level tool) on the wet concrete which can cause damage to the level tool, e.g., due to the abrasive nature of concrete. Additionally, when working concrete, the user often does not have time to stop to clean the conventional level tool from concrete, resulting in concrete drying on the level tool.

In some embodiments, the electronic handle 102 includes a temperature sensor 144. The temperature sensor 144 may output data indicative of the temperature at the electronic handle 102. The processor 120 may be in communication with the temperature sensor 144 and receive the sensor data of the temperature sensor 144. The processor 120 may use the temperature data in determining the orientation of the electronic handle 102. For example, the ambient temperature at the orientation sensor 124 may impact the performance of the orientation sensor 124 (e.g., such that the output sensor data is affected by the ambient temperature). The processor 120 may use the temperature data to interpret the sensor data of the orientation sensor 124 to provide a temperature compensated attitude angle estimates. In some forms, the processor 120 may present the temperature on the electronic display 136 to the user.

The memory 122 may store a calibration algorithm and a sensor fusion algorithm. The processor 120 may execute the calibration algorithm to calibrate the electronic handle 102 to provide accurate angle readings. When executing the calibration algorithm, the processor 120 may receive sensor data of the orientation sensor 124 and store the sensor data in memory 122 for conditioning the sensor fusion algorithm. The processor 120 may execute the sensor fusion algorithm to calculate the attitude angle of the electronic handle. The sensor fusion algorithm combines the data from the orientation sensor to provide accurate orientation measurements despite sensor noise and/or sensor drift in the accelerometer and gyroscope data. When executing the sensor fusion algorithm, the processor 120 may combine the data from the orientation sensor 124 and the temperature sensor 144 to output angle measurements of the electronic handle 102. For example, the processor 120 may combine the data of an accelerometer and a gyroscope of the orientation sensor 124 and the data of the temperature sensor 144 to provide accurate temperature compensated attitude angle estimates. In one approach, the sensor fusion algorithm uses a Kalman filter to combine data of the accelerometer and gyroscope to obtain an accurate orientation measurement, despite a high degree of noise in the accelerometer and gyroscope data. The Kalman filter provides high accuracy and stability. In another approach, the sensor fusion algorithm uses a Magwick's filter to combine data of the accelerometer and gyroscope to obtain an accurate orientation measurement. The Magwick's filter provides efficient orientation estimation using quaternions. In either approach, the output of the sensor fusion algorithm is less susceptible error due to gyroscope drift and/or accelerometer noise/disturbances.

The electronic handle 102 may include Global Navigation Satellite System (GNSS) circuitry 146. The GNSS circuitry 146 is configured to receive GNSS data from satellites of one or more GNSS's to determine a location and/or orientation of the electronic handle 102 on earth. Examples of GNSS include GPS, GLONASS, BeiDou, and Galileo. The GNSS circuitry 146 may be configured to perform real-time kinematic (RTK) positioning. Use of RTK techniques may enable accurate measurements of the elevation or height of the electronic handle 102 relative to the earth (e.g., from sea level or some other reference elevation). In some forms, the electronic handle 102 may be able to detect its elevation within a centimeter. Where the GNSS circuitry 146 uses RTK techniques, the GNSS circuitry 146 may receive signals from the satellite system and a base station positioned on the ground, e.g., a base station at the job site. Based on the signals from the satellite system and the base station, the processor 120 is able to determine the position and/or elevation of electronic handle 102 with high accuracy (e.g., within a centimeter, within half a centimeter). Determining the elevation of the electronic handle 102 may permit the processor 120 to output an elevation of the hand float 100 to a user (e.g., via the display 136). Where the processor 120 displays elevation data, a worker using the hand float 100 may detect the height of the concrete as they are working the concrete. Detecting the height of the concrete may enable the worker to adjust the height of the concrete to the desired elevation. For example, when pouring a footing for a building, a worker may use the elevation output of the electronic handle 102 to ensure that the top surface of the footing does not vary by more than a certain distance (e.g., a half centimeter). And, where multiple workers are finishing the concrete simultaneously, the workers may refer to the elevation data of their hand floats to ensure both workers are leveling the concrete to substantially the same height.

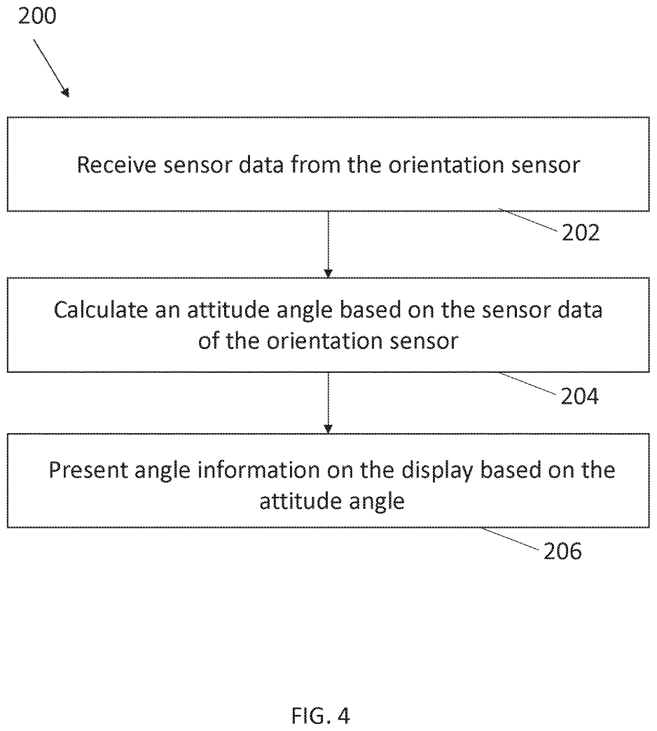

With respect to FIG. 4, the processor 120 may operate according to method 200 to present angle information of the electronic handle 102. In operation, the electronic handle 102 may receive input from a user to turn on, for example, via button 138A. The processor 120 may be configured to turn off the electronic handle 102 or go into a sleep mode after a period of inactivity (e.g., one minute). Upon receiving input to turn on, the processor 120 receives 202 sensor data of the orientation sensor 124 and/or temperature sensor 144. The processor 120 may run the calibration algorithm to calibrate the electronic handle 102. For example, the processor 120 may receive and store in memory 122 the sensor data of the orientation sensor 124 and/or temperature sensor 144. This stored sensor data of the orientation sensor 124 and/or temperature sensor 144 is used to correct for errors, such as errors due to temperature fluctuations. In the calibration algorithm, the processor 120 may store a data structure (e.g., a table of values) in memory 122 that includes correction factors to be applied to either accelerometer or gyroscope data based on the present temperature.

The processor 120 calculates 204 the attitude angle of the electronic handle 102 with respect to the reference plane 103 (e.g., a horizontal plane perpendicular to the direction of gravity). For example, the processor 120 may execute the sensor fusion algorithm to determine the attitude angle of the electronic handle 102 based on data from the orientation sensor 124 (e.g., accelerometer and/or gyroscope data). The sensor fusion algorithm may use one or more filters to account for gyroscope drift and accelerometer noise and disturbances to output accurate orientation data. For example, the sensor fusion algorithm may use a Kalman filter to combine the data of the accelerometer and gyroscope to obtain an accurate orientation measurement. Additionally or alternatively, the sensor fusion algorithm may use a Magwick's filter to combine data of the accelerometer and gyroscope to obtain an accurate orientation measurement. The attitude angle calculation may be based in part on the calibration.

The processor 120 present 206 angle information on the electronic display 136 based on the calculated attitude angle. For example, the processor 120 may present the attitude angle, the slope, the slope percent, degree, millimeters per meter, inches per foot. The angle information may also include an indication 140 of which direction the electronic handle 102 is sloped, for example, an arrow pointing downward to indicate the direction fluid would flow on a surface of that angle. The processor 120 may receive input from the user to adjust the type of angle information displayed, for example, to select the format in which the angle information is displayed (e.g., attitude angle, slope, slope percent).

In use, the user turns the electronic handle 102 on, for example, by pressing a button 138A of the user interface 128. The user places the hand float 100 on the surface they desire to measure the slope of, for example, the surface of uncured concrete. The user can then read the angle information (e.g. slope percent) presented via the electronic display 136 of the user interface 128 to determine the slope of the measured surface. When working concrete, the user can use the hand float 100 to work the concrete and also to measure the slope of the concrete surface. The user may thus measure the slope of the concrete with the same tool they are using to work the concrete. Indeed, the user need not even remove their hand from the hand float 100 to measure the slope. The electronic handle 102 thus enables a user to more quickly measure and work the concrete to the desired slope, reducing the time to finish the concrete. Reducing the time to finish the concrete not only enables a project to be completed more quickly but is especially advantageous especially when working concrete where the concrete is workable for a short period of time before curing. Moreover, because the user does not need to switch tools to measure the slope, there is a less of a barrier for the user to measure the slope such that user will tend to measure the slope more frequently, reducing the chance for undetected errors and ensuring the desired slope is achieved along the length and/or width of a concrete slab. Where the angle information indicates the direction of the slope, the user is able to visually determine not only that the concrete surface has the desired slope, but is also sloped in the right direction, further reducing error.

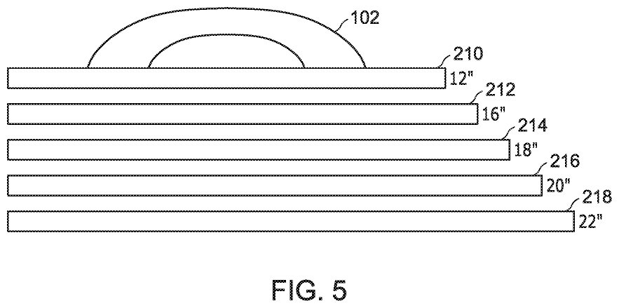

With respect to FIG. 5, the electronic handle 102 may be used with float blades of a variety of sizes. As examples, the electronic handle 102 may be used with a 12-inch float blade 210, a 16-inch float blade 212, an 18-inch float blade 214, a 20-inch float blade 216, and a 22-inch float blade 218. The electronic handle 102 may be interchangeable such that the electronic handle 102 can be attached to a float blade having the desired length, e.g., for a particular project. In other words, the electronic handle 102 can be removed from a float blade of one size and attached to a float blade of another size.

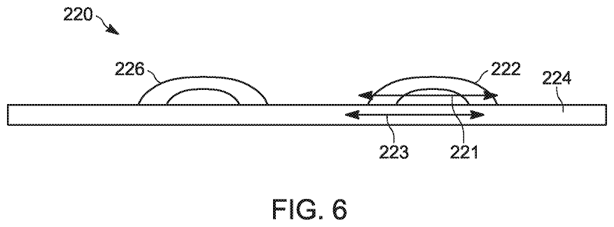

With respect to FIG. 6, a screed 220 is provided having an electronic handle 222 is shown attached to a screed board 224. The electronic handle 222 is similar in many respects to the electronic handle 102 discussed above such that similar reference numerals will be used to indicate similar components. In one embodiment, the electronic handle 222 is attached to the screed board 224 with fasteners that extend into the openings 116, 118 of electronic handle 102 and into the screed board 224 similar to how the electronic handle 102 is attached to the float blade 104. The screed board 224 may be a variety of lengths including, as examples, a four-foot screed board, a six-foot screed board, a ten-foot screed board, a 12 foot screed board, or a 14 foot screed board. The electronic handle 222 may be attached such that a longitudinal axis 221 of the electronic handle 222 is parallel to the longitudinal axis 223 of the screed board 224. The screed 220 may be used to flatten and smooth the wet concrete surface. For example, the user may drag the screed board 224 over the wet concrete to form a smooth, uniform, flat surface. In some projects, the concrete surface is to have a slope. The user may work the concrete with the screed board 224 to have a surface with the desired slope. The electronic handle 102 may present angle information (e.g., pitch angle and/or roll angle information) to the user of the slope of the electronic handle 102 (and thus the screed board 224 to which the electronic handle 102 is affixed) as discussed above with respect to the hand float 100. Thus, the user may position the screed board 224 on the concrete surface to measure the slope of the concrete surface with the electronic handle 222. The screed 220 includes a second handle 226 to provide the user with another handle to use to move the screed 220, e.g., when working concrete. The second handle 226 may be a second electronic handle 222 or may be a conventional, non-electronic handle. In some forms, the screed 220 includes two electronic handles 222 to provide redundancy, for example, to permit a user to view of the slope measurement from both handles 222.

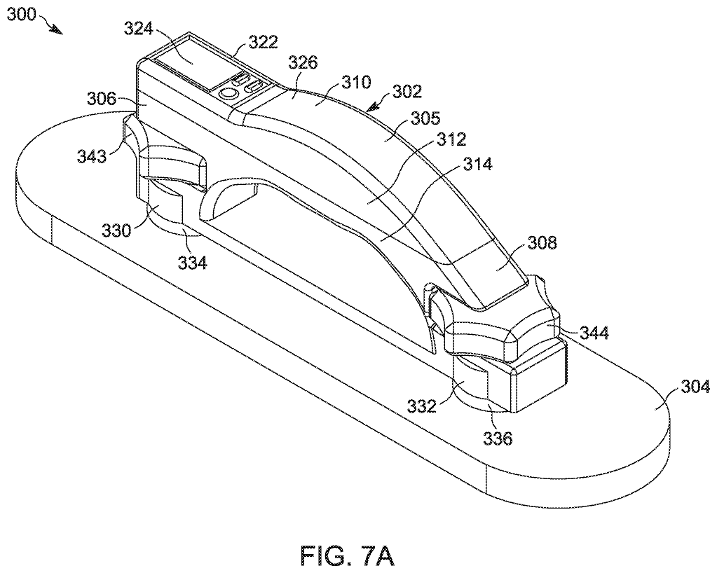

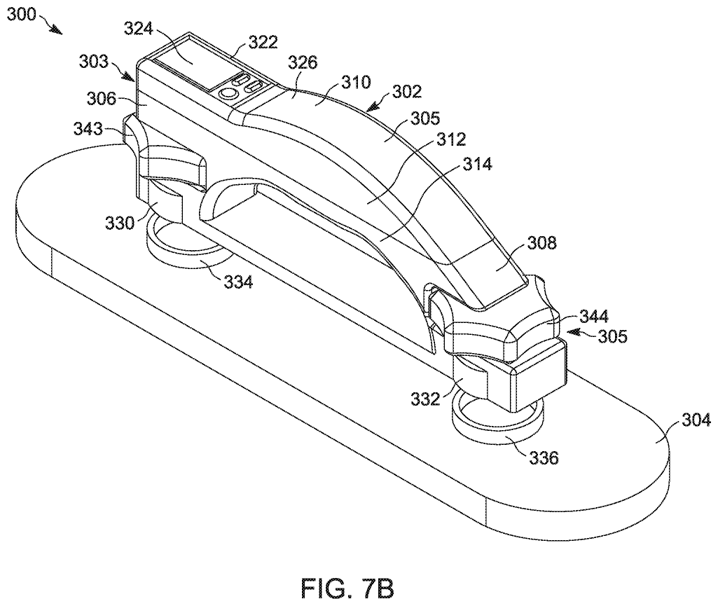

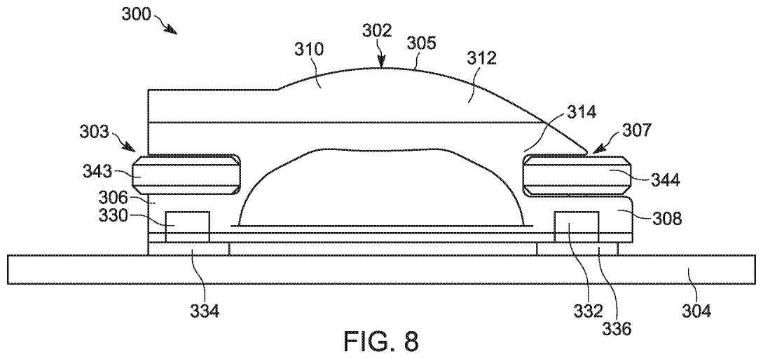

With respect to FIGS. 7A-9, a hand float 300 is provided according to another embodiment that has a quick-attach mechanism. The hand float 300 includes an electronic handle 302 and a float blade 304. The hand float 300 and electronic handle 302 are similar to the previous embodiments such that the differences primarily are highlighted. The quick-attach mechanism enables the electronic handle 302 to be easily attached to (FIG. 7A) and detached from the float blade 304 (FIG. 7B), as discussed below. While the electronic handle 302 is shown attached to a float blade 304, the electronic handle 302 could similarly be used with other tools, such as the screed board 224 of FIG. 6. The quick-attach mechanism can enables the electronic handle 302 to quickly be attached to or detached from various tools to enable use of the electronic handle 302 with a variety of tools.

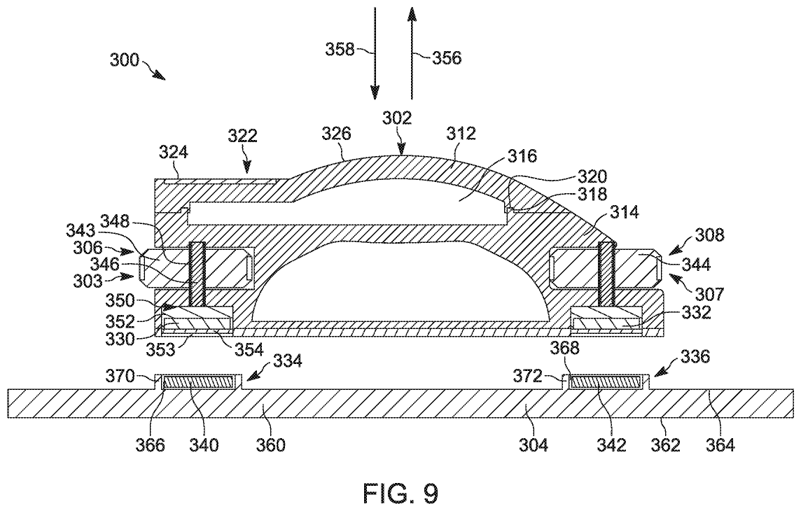

The electronic handle 302 includes a handle body 305 having a grasping portion 310 extending between a first attachment portion 306 and a second attachment portion 308. With reference to FIG. 9, the handle body 305 includes a first upper portion 312 secured to a second lower portion 314 to form a watertight compartment 316 to house the electronics of the handle 302, similar to the embodiments discussed above. In some forms, the first upper portion 312 is secured to the second lower portion 314 with an adhesive to inhibit separation of the first upper portion 312 and second lower portion 314. In some forms, the first upper portion 312 is secured to the second lower portion 314 with one or more fasteners. The electronic handle 302 includes a seal member 318, such as an O-ring, extending about the periphery of the watertight compartment 316 to form a fluid tight seal between the first upper portion 312 and the second lower portion 314 of the handle body 305. The first upper portion 312 may include a notch 320 receiving the seal member 318 to hold the seal member 318 in place between the first upper portion 312 and the second lower portion 314.

The electronic handle 302 includes a user interface 322 similar to the embodiments discussed above with an electronic display 324 to display angle information to the user. The user interface 322 may be mounted on a top of the handle body 305 to be visible to the user when holding the grasping portion 310 with their hand. The handle body 305 may extend about the sides of the electronic display 324 to shield the electronic display 324 from contact with objects the electronic handle 302 may come into contact with. In some forms, the electronic display 324 is substantially flush with a top surface 326 of the handle body 305 to inhibit the buildup of debris (e.g., concrete) on or about the electronic display 324 and to make cleaning the electronic handle easier (e.g., to enable the top surface 326 and electronic display 324 to be easily wiped free from debris).

The quick-attach mechanism of the electronic handle 302 is configured to magnetically attach the electronic handle 302 to the float blade 304. The quick-attach mechanism includes a first quick-attach mechanism 303 and a second quick-attach mechanism 307. The first quick-attach mechanism 303 includes a first magnetic component such as first magnet 330 at the first attachment portion 306 and the second quick-attach mechanism 307 includes a second magnetic component such as second magnet 332 at the second attachment portion 308. The float blade 304 (or screed board or other tool to which the electronic handle is to be attached) includes a first attachment portion 334 and a second attachment portion 336 corresponding to the first and second attachment portions 306, 308 of the electronic handle 302. The float blade 304 includes a magnetic component such as magnet 340 at the first attachment portion 334 and a magnetic component such magnet 342 at the second attachment portion 336 to magnetically interact with the magnets 330, 332 of the electronic handle 302 to secure the electronic handle 302 to the float blade 304. For example, the first magnet 330 of the first attachment portion 306 of the electronic handle 302 is magnetically attracted to the magnet 340 at the first attachment portion 334 of the float blade 304 and the second magnet 332 of the second attachment portion 308 of the electronic handle 302 is magnetically attached to the magnet 342 at the second attachment portion 336 of the float blade 304. Thus, when the first and second attachment portions 306, 308 of the electronic handle 302 are aligned with and brought in proximity to the first and second attachment portions 334, 336 of the float blade 304, the magnets may draw the electronic handle 302 toward the float blade 304 and thereby secure the electronic handle 302 to the float blade 304.

In some forms, the magnetic poles of the magnets of the electronic handle 302 and float blade 304 are arranged such that electronic handle 302 can only be attached to the float blade 304 in a specific orientation. For example, the first magnet 330 at the first attachment portion 306 may have its magnetic north pole facing outward toward the float blade 304 and the second magnet 332 of the second attachment portion 308 may have its magnetic south pole facing outward toward the float blade 304. The magnet 340 at the first attachment portion 334 of the float blade 304 may have its magnetic south pole facing outward toward the electronic handle 302 and the magnet 342 at the second attachment portion 336 of the float blade 304 may have its magnetic north pole facing outward toward the electronic handle 302. Thus, the electronic handle 302 can be attached to the float blade 304 when the first attachment portion 306 of the electronic handle 302 is aligned with the first attachment portion 334 of the float blade 304 and the second attachment portion 308 of the electronic handle 302 is aligned with the second attachment portion 336 of the float blade 304. When attempting to attach in the reverse orientation, the magnets repel one another inhibiting attachment.

In other forms, the first magnetic component at the first attachment portion 306 may be a ferromagnetic material and the magnetic component at the first attachment portion 334 of the float blade 304 may be a magnetic material or vice versa, which permits the first attachment portion 306 to be magnetically secured to the first attachment portion 334 of the float blade 304. Similarly, the second magnetic component at the second attachment portion 308 may be a ferromagnetic material and the magnetic component at the second attachment portion 336 of the float blade 304 may be a magnetic material or vice versa, which permits the second attachment portion 308 to be magnetically secured to the second attachment portion 336 of the float blade 304.

The first quick-attach mechanism 303 of the electronic handle 302 may include an actuator such as a knob 343 at the first attachment portion 306 to lock or release the electronic handle 302 to the float blade 304. For example, the knob 343 may be rotated to move the magnet 330 toward (in direction 358) or away from (in direction 356) the float blade 304 between a locked configuration and an unlocked configuration to lock the electronic handle 302 to or release the electronic handle 302 from the float blade 304. The second quick-attach mechanism 307 may similarly include an actuator such as attachment knob 344 at the second attachment portion 308 that is rotatable to raise or lower the magnet 332 relative to the float blade 304 between a locked configuration and an unlocked configuration. When the magnets 330, 332 are moved toward the float blade 304 in direction 358 to the locked configuration, the force of magnetic attraction is significant (e.g., 60 lbf), securing the electronic handle 302 to the float blade 304. When the magnets 330, 332 are moved away from the float blade 304 in direction 356 to the unlocked configuration, the force of magnetic attraction is significantly reduced (e.g., 5 lbf, 10 lbf) due to the increased distance between the magnets 330, 332 of the electronic handle 302 and the corresponding magnets 340, 342, permitting the electronic handle 302 to be easily separated from the float blade 304.

Referring to FIG. 9, the magnet 330 of the first quick-attach mechanism 303 of the electronic handle 302 is attached to a threaded shaft 346 that extends through a threaded hole 348 of the attachment knob 343. In the form shown, the magnet 330 is disposed in a case 350 secured to the threaded shaft 346. As one example, the magnet 330 may be secured to the case 350 with an adhesive. The case 350 may include a base 352 and a lid 354 enclosing the magnet 330 therein. The second lower portion 314 of the handle body 305 includes a recess 353 in which the case 350 and magnet 330 are disposed. The magnet 330 may be moved along in the recess 353 between the locked and unlocked configurations.

The knob 343 of the first quick-attach mechanism 303 may be rotated to move the magnet 330 between the locked configuration and the unlocked configuration. Rotation of the knob 343 in a first direction causes the threaded hole 348 of the attachment knob 343 to engage the threaded shaft 346 and draw the threaded shaft 346 and magnet 330 in direction 356 away from the float blade 304, to the unlocked configuration. Rotation of the knob 343 in a second direction causes the threaded hole 348 of the attachment knob 343 to engage the threaded shaft 346 and urge the threaded shaft 346 and magnet 330 in direction 358 toward the float blade 304, to the locked configuration. The second quick attach mechanism 307 may be similar to first quick-attach mechanism 303 such that discussion of the first quick-attach mechanism 303 similarly applies to the second quick-attach mechanism 307 and will not be repeated for conciseness and clarity.

The float blade 304 includes a float body 360 having a bottom surface 362 and a top surface 364 opposite the bottom surface 362. The top surface 364 of the float body 360 includes the first attachment portion 334 and second attachment portion 336. The first attachment portion 334 and second attachment portion 336 may each include recesses 366, 368 receiving the magnets 340, 342. The recesses 366, 368 may be formed by a wall 370, 372 protruding from the top surface 364 of the float body 360. In some embodiments, the electronic handle 302 mechanically engages the float blade 304 when secured thereto to inhibit lateral or longitudinal movement of the electronic handle 302 relative to the float blade 304. In some forms, when the magnets 330, 332 of the electronic handle 302 are moved to the locked configuration, the magnets 330, 332 extend outward below the handle body 305 to be at least partially extended into the recesses 366, 368 of the float blade 304. With the magnets 330, 332 extending into the recesses 366, 368, the walls 370, 372 defining the recesses 366, 368 limit lateral and longitudinal movement of the magnets 330, 332 and thus the electronic handle 302 relative to the float blade 304. In other forms, the handle body 305 of the electronic handle 302 include recesses to receive the walls 370, 372 of the float blade 304 when the electronic handle 302 is secured to the float blade 304 to limit longitudinal and/or lateral movement of the electronic handle 302 relative to the float blade 304 (e.g. due to shear force).

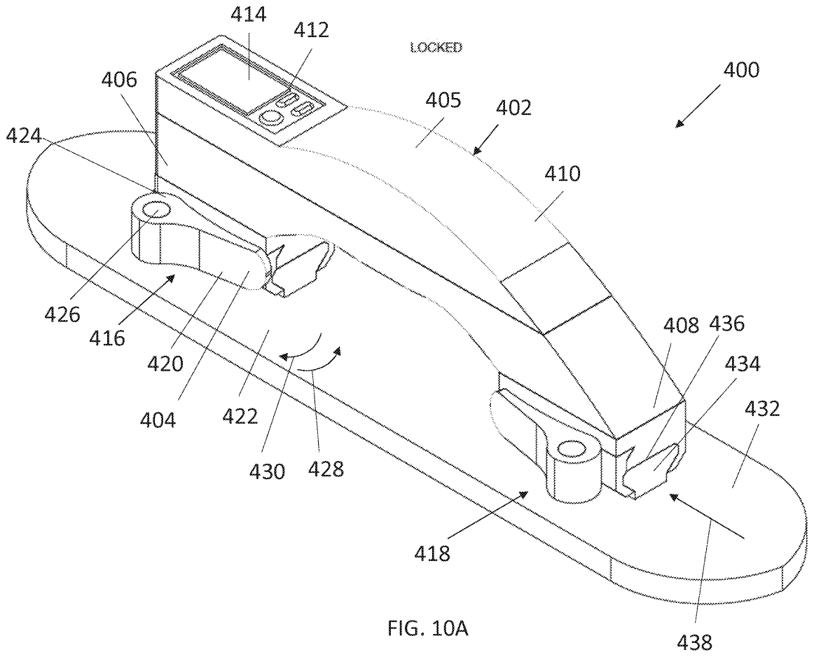

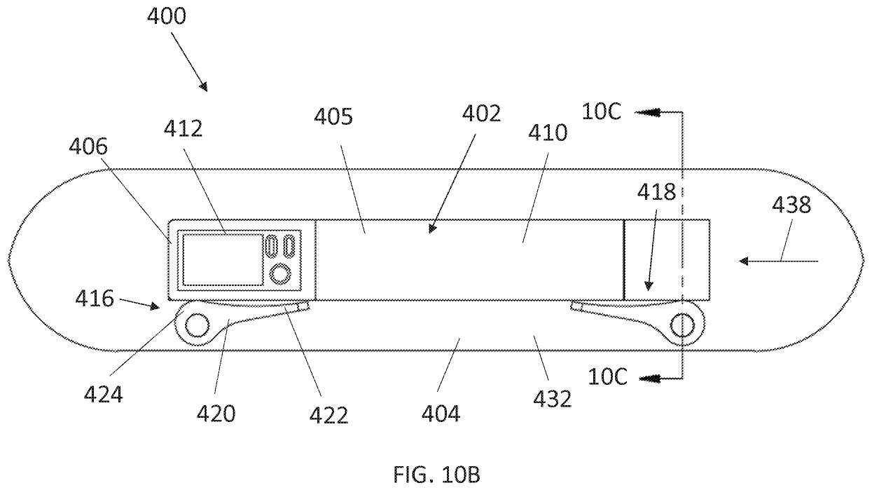

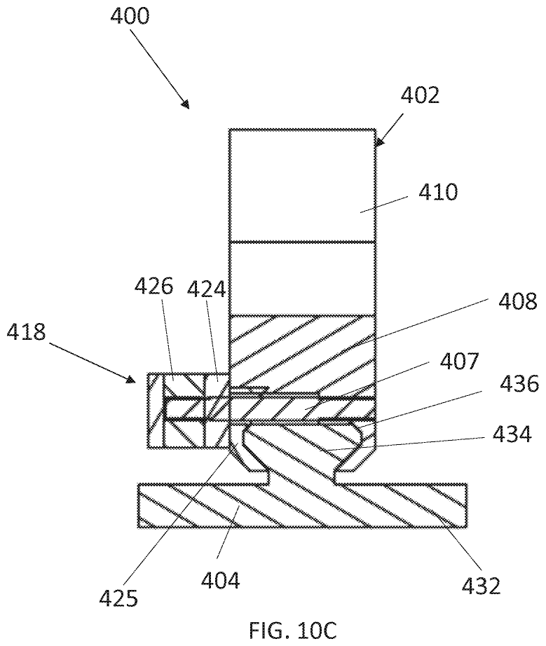

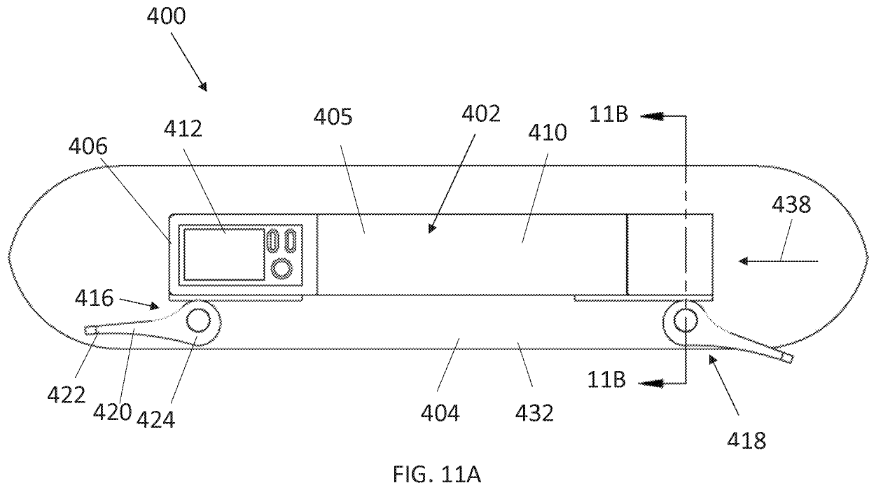

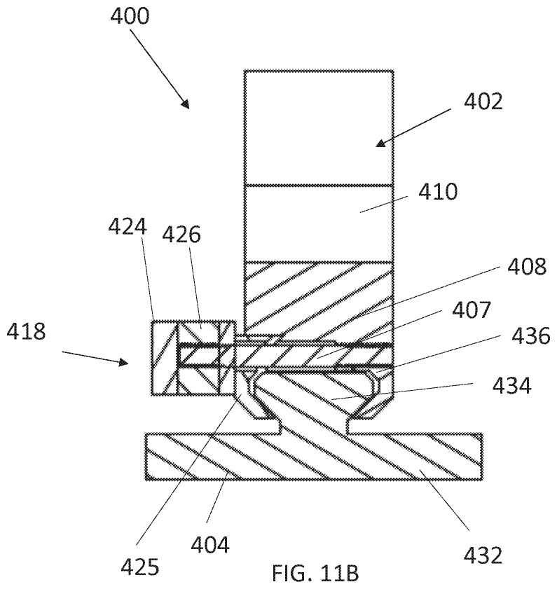

Regarding FIGS. 10A-11B, a hand float 400 is provided according to another embodiment that has a quick-attachment mechanism. The hand float 400 is similar in many respects to the embodiment discussed above such that the differences are primarily highlighted. The hand float 400 includes an electronic handle 402 releasably attachable to a float blade 404.

While the following discussion describes the electronic handle 402 attached to the float blade 404, the electronic handle 402 could similarly be releasably attached to other tools as discussed above, for example, a screed board.

The electronic handle 402 includes a handle body 405 having a first attachment portion 406, a second attachment portion 408, and a grasping portion 410 extending between the first attachment portion 406 and second attachment portion 408. The handle body 405 houses the electronics (e.g., the orientation sensor and processor) and supports a user interface 412 which includes an electronic display 414. The first attachment portion 406 includes a quick-attach mechanism 416. The second attachment portion 408 includes a quick-attach mechanism 418 that is similar to the quick-attach mechanism 416 of the first attachment portion 406 such that that discussion of the quick-attach mechanism 416 similarly applies to the quick-attach mechanism 418 and will not be repeated for conciseness and clarity.

The quick-attach mechanism 416 includes a lever 420 having a lever arm 422 and a cam portion 424 pivotable about a pin 426. The pin 426 may be secured to the handle body 405 by a fastener 407. For example, one end of the fastener 407 may be attached to the pin 426 (e.g. via threading) and the other end of the fastener 407 may be attached to the handle body 405 (e.g., via threading). The lever arm 422 may be pivoted about the pin 426 in direction 428 to a securing position shown in FIGS. 10A-10C which causes the cam portion 424 to drive a brake member 425 to a securing position. The lever arm 422 may be pivoted about the pin 426 in direction 430 to a release position shown in FIGS. 11A-11B which disengages the cam portion 424 and releases the brake member 425. In the embodiment shown, the lever 420 of the quick-attach mechanism 418 extends in the opposite direction of the lever 420 of the quick-attach mechanism 416. For example, the levers 420 may extend toward one another when in the securing position and away from one another when in the release position. The lever 420 of the quick-attach mechanism 418 may be pivoted in the opposite direction of the lever 420 of the quick-attach mechanism 416 to move between the securing position and release position. In other embodiments, the levers 420 may extend in the same direction and be pivoted in the same direction to move between the securing position and release position.

The float blade 404 includes a main body 432 and one or more attachment rails 434. The attachment rails 434 may have a shape to be received into slots 436 of the first attachment portion 406 and second attachment portion 408 of the handle body 405 to permit the handle body 405 to slid longitudinally along the attachment rails 434 but inhibit separation in the lateral or transverse directions. In the example shown, the attachment rail 434 has a dovetail shape and the slot 436 of the first and second attachment portions 406, 408 have a corresponding dovetail shape. In other forms, the attachment rail 434 and slot 436 may have other shapes, for example, a T-shape. In other forms, the float blade 404 includes the slot and the first and second mounting portions 406, 408 of the handle body 405 include the rail.

To attach the electronic handle 402 to the float blade 404, the lever arms 422 of the quick-attach mechanism 416, 418 may be moved to their release positions. The slot 436 of the first and second mounting portions 406, 408 may be axially aligned with the attachment rails 434 of the float blade 404. The electronic handle 402 may be moved in direction 438 to slide the electronic handle 402 axially relative to the float blade 404 and to receive the attachment rails 434 into the slot 436. The first mounting portion 406 may include a stop on the slot 436 that contacts the attachment rail 434 received therein, for example, to set the axial position of the electronic handle 402 relative to the float blade 404 and limit insertion of the attachment rail 434 into the slot 436. When mounting the electronic handle 402, the electronic handle 402 may be slid in direction 438 until the attachment rail 434 contacts the stop.

The lever arms 422 of the quick-attach mechanism 416, 418 may then be moved to their securing positions to cause the cam portions 424 to drive the brake members 425 to their securing positions. When the brake members 425 are in their securing positions, the brake members 425 are urged into frictional engagement with the attachment rail 434 to inhibit the electronic handle 402 from sliding axially along the float blade 404, thus securing the electronic handle 402 to the float blade 404.

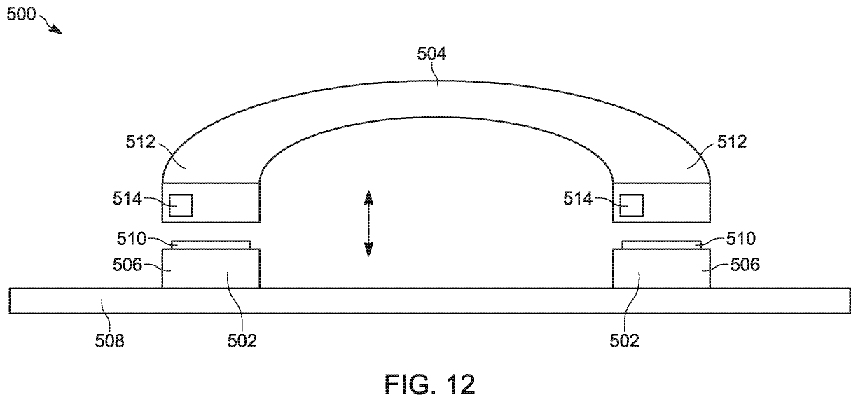

With respect to FIG. 12, a hand float 500 is provided according to another embodiment that includes adapters 502 to secure an electronic handle 504 to a conventional float blade. The adapters 502 each include a body 506 to be secured to a float blade 508, such as a float blade of a conventional non-electronic hand float. The body 506 may be secured to the float blade 508 with a fastener, such as screw, or nut and bolt. For example, the fasteners may extend through the attachment holes of the float blade 508 to which a conventional, non-electronic handle is attachable to the float blade 508. The adapters 502 may each include an attachment portion 510 to which the electronic handle 504 is removably attachable. The electronic handle 504 includes attachment portions 512 having a quick-attach mechanism 514, which may be like the quick attach mechanism 303 or quick-attach mechanism 416 discussed above. The attachment portion 510 of the adapters 502 may be like the attachment portion 334/magnet 340 of the hand float 300 discussed above or the attachment rails 434 of the hand float 400 discussed above to permit the electronic handle 504 to be removably attached to the adapters 502 via the quick-attach mechanism 514 in the manner discussed above. The adapters 502 could similarly be mounted to other tools, such as those discussed above (e.g., a screed board), to permit the electronic handle 504 to be releasably attached to such tools.

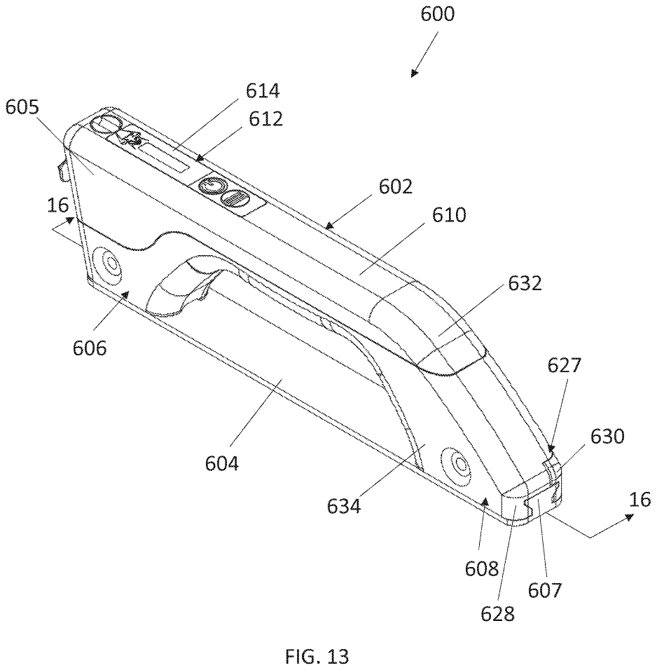

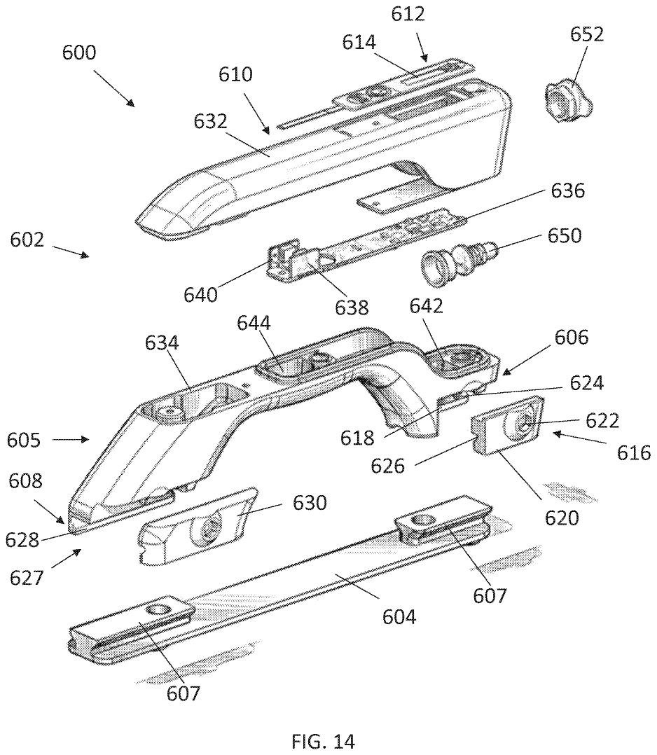

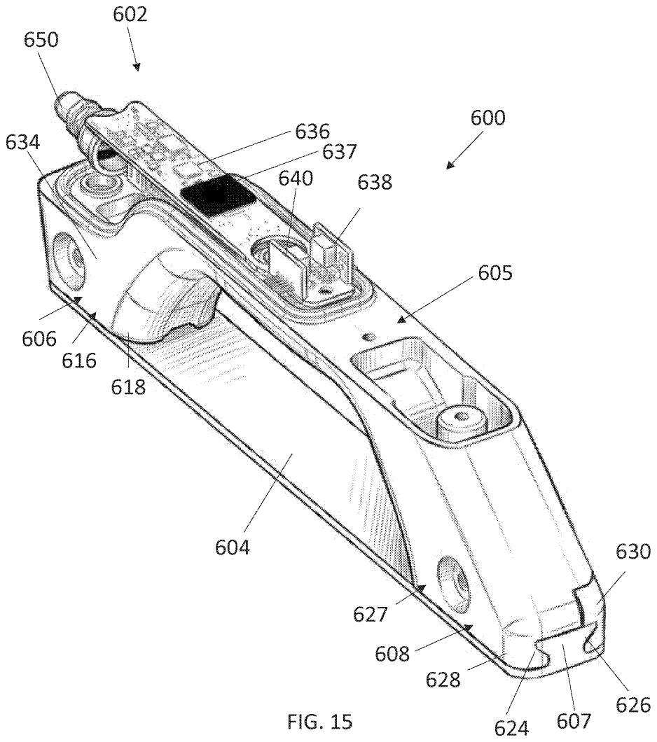

Regarding FIGS. 13-17, a hand float 600 is provided according to another embodiment that is similar in many respects to the embodiment discussed above such that the differences are primarily highlighted. The hand float 600 includes an electronic handle 602 releasably attachable to a float blade 604. While the following discussion describes the electronic handle 602 attached to the float blade 604, the electronic handle 602 could similarly be releasably attached to other tools as discussed above, for example, a screed board.

The electronic handle 602 includes a handle body 605 having a first attachment portion 606, a second attachment portion 608, and a grasping portion 610 extending between the first attachment portion 606 and second attachment portion 608. The handle body 605 houses the electronics (e.g., the orientation sensors 638, 640 and processor 637) and supports a user interface 612 which includes an electronic display 614 similar to the embodiments discussed above.

The first attachment portion 606 includes a clamp 616 to secure the handle body 605 to a rail portion 607 of the float blade 604. The clamp 616 includes a fixed portion 618 of the handle body 605, a brake or movable portion 620 of the handle body 605, and a bolt 622 connecting the fixed portion 618 and movable portion 620 together. The bolt 622 may engage a threaded opening of the fixed portion 618, for example, of nut secured to the fixed portion 618. The bolt 622 may be rotated in a first direction to draw the movable portion 620 toward the fixed portion 618 and to clamp the rail portion 607 of the float blade 604 therebetween. The bolt 622 may be a wing bolt, having wings that enable a user to grasp the head of the bolt 622 to turn the bolt 622.

The fixed portion 618 and/or movable portion 620 may include a groove or recess 624, 626 that form a slot to receive a portion of the rail portion 607 of the float blade 604 therein to form a positive locking engagement therebetween that inhibits the float blade 604 from shifting vertically relative to the handle body 605. For example, the rail portion 607 of the float blade 604 may have a dovetail configuration onto which the fixed portion 618 and movable portion 620 clamp. The fixed portion 618 and movable portion 620 may be clamped tightly to the rail portion 607 of the float blade 604, applying a frictional force to inhibit the float blade 604 from shifting longitudinally relative to the handle body 605. The bolt 622 may be rotated in an opposite, second direction to release the float blade 604 from the electronic handle 602. Upon rotating the bolt 622 in the second direction, the movable portion 620 may be shifted away from the fixed portion 618, permitting the rail portion 607 of the float blade 604 to move longitudinally relative to the electronic handle 602.

The second attachment portion 608 includes a clamp 627 with a fixed portion 628 and a movable portion 630 to secure the electronic handle 602 to the float blade 604 similar to the first attachment portion 606 such that discussion will not be repeated for conciseness and clarity. When both the first attachment portion 606 and the second attachment portion 608 are in the released configurations, the electronic handle 602 may be slid longitudinally onto or off of the float blade 604 as discussed above to secure or release the electronic handle 602 to or from the float blade 604.

In other embodiments, the first attachment portion 606 and second attachment portion 608 include a cam lever (like lever 420 discussed above), rather than a bolt 622, to quickly secure and release the electronic handle 602 from the float blade 604.

The handle body 605 includes an upper portion 632 connected to a lower portion 634. The upper portion 632 and lower portion 634 form one or more cavities housing electronic components of the electronic handle 602, such as a battery and a circuit board 636. The circuit board 636 may include a processor 637, memory, charging circuitry, GNSS circuitry, and a temperature sensor as discussed above.

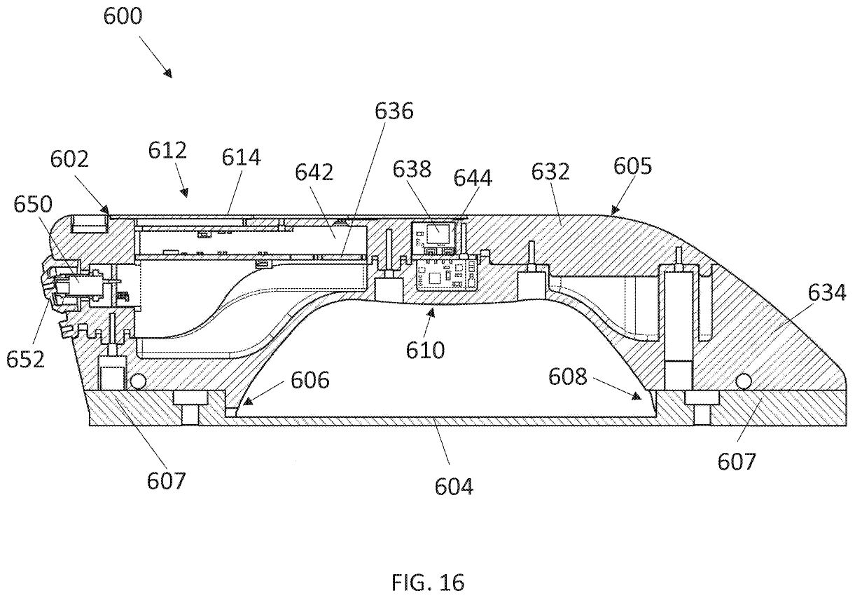

With reference to FIG. 16, the handle body 605 defines two cavities 642, 644 separated from one another. The orientation sensors 638, 640 may be disposed in the second cavity 644 and the battery, processor 637, and other electrical components may be disposed in the first cavity 642. Keeping the orientation sensors 638, 640 separated from the other electronic components aids to thermally insulate the orientation sensors 638, 640 from the other electronic components. The orientation sensors 638, 640 may be sensitive to temperature, with the output signal varying based on temperature. Keeping the orientation sensors 638, 640 separated from other heat generating components of the electronic handle 602 avoids exposing the orientation sensors 638, 640 to relatively rapid changes in temperature due to heat dissipated from the other electrical components.

The circuit board 636 includes two orientation sensors 638, 640 mounted with different orientations, for example, mirrored relative to one another. The orientation sensors 638, 640 output data indicative of the orientation of the electronic handle 602, for example, data to determine the orientation of the electronic handle 602 relative to a reference plane, such as a horizontal plane perpendicular to the direction of gravity.

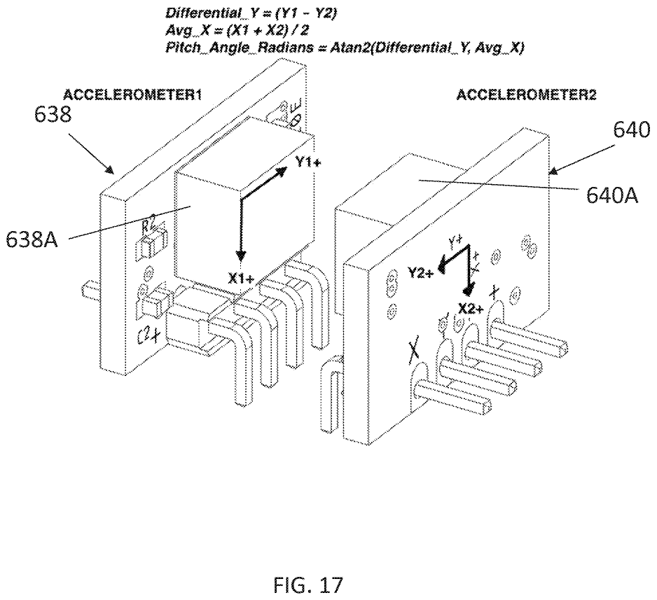

Referring to FIG. 17, the orientation sensor 638 includes a first accelerometer 638A and the orientation sensor 640 includes a second accelerometer 640A. As illustrated, the first accelerometer 638A is oriented so that the direction of the positive y-axis, Y1+, is opposite the direction of the positive y-axis, Y2+, of the second accelerometer 640A. The y-axes of the accelerometers 638A, 640A extend generally along the length of the electronic handle 602 (e.g., +/−5 degrees). The x-axes of the accelerometers 638A, 640A extend generally along the height of the electronic handle 602 (e.g., toward the float blade 604) (e.g., +/−5 degrees). The processor 637 of the electronic handle 602 may use the x-axis data and y-axis data of the accelerometers 638A, 640A to measure an inclination or pitch angle of the electronic handle 102. For example, where the electronic handle 602 is level, the direction of gravitational acceleration is in the x-axis. As the pitch of the electronic handle 602 changes, a component of the gravitational acceleration shifts to the y-axis. For example, as the pitch of the handle 602 increases, the component of the gravitational acceleration in the y-axis increases while the component of gravitational acceleration in the x-axis decreases and vice versa.

With two accelerometers 638A, 640A having positive y-axes in opposite directions, a differential output in the y-axis is provided that filters out noise and thus increases the signal to noise ratio of the signal indicating the direction of gravitational acceleration. The processor 637 may calculate a differential Y-value based on the signals from the two accelerometers 638A, 640A, for example, by subtracting the Y2+ reading from the Y1+ reading, which doubles the strength of the signal in the y-axis. If both accelerometers 638A, 640A pick up noise in the same direction along the y-axis, this noise is canceled out upon calculating the differential Y value (e.g., noise in one direction in one sensor is offset by the same noise in the other sensor). If one accelerometer picks up noise in the y-axis but the other does not, upon calculating the differential Y-value, the strength of that noise relative to the overall differential signal is reduced by about 50% because the signals from the two accelerators 638A, 640A are combined. The differential accelerometer arrangement aids to minimize noise and thereby reduces the impact of noise on the sensor readings. The processor may calculate an average X-value based on the signals from the two accelerometers 638A, 640A, for example, by adding the sensor readings in the x-axis and dividing by two. The processor may calculate the direction of gravitational acceleration relative to the electronic handle 602 by applying an arctangent function to the differential Y-value and average X value. For example, the processor may determine that the pitch angle of the electronic handle 602 according to the formula: Pitch Angle=atan2(differential Y-value, average X-value).

In other forms, the accelerometers 638A, 640A are mounted so that the x-axes of the accelerometers 638A, 640A are in opposite directions and a differential X-value is calculated similar to the differential Y-value discussed above and used in place of the average X-value. For example, a differential may be calculated for both the X-value and/or the Y-value.

The differential orientation sensing configuration of the electronic handle 102, with mirrored accelerometers 638A, 640A, effectively cancels noise as noise present in one orientation sensor is offset by the opposite orientation of the other. So configured, a calibration routine may be omitted because noise is sufficiently filtered out, enabling the processor 637 to accurately calculate the pitch angle. The differential orientation sensing configuration of the electronic handle 602 provides a substantial improvement in noise rejection and measurement stability over single-sensor configurations, enabling accurate pitch angle detection of the electronic handle 602.

The electronic handle 602 includes an electrical port 650. The electrical port 650 may be used to charge the battery of the electronic handle 602 and/or for reprogramming the electronic handle 602. The electrical port 650 may be, as one example, a USB port. With a USB port, the battery may be readily charged in a vehicle as a user is traveling to or between jobsites. The electronic handle 602 includes a plug 652 that may be removably inserted into a recess 654 of the electronic handle 602 to close off access to the electrical port 650 and inhibit liquid and debris (e.g., water, concrete) from reaching the electrical port 650. The plug 652 may be withdrawn from the recess 654 to access the electrical port 650, for example, for charging.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A concrete forming tool comprising:
a handle body to be attached to a tool body;
an orientation sensor disposed in the handle body and configured to output orientation data;
an electronic display attached to the handle body; and
a processor operatively coupled to the orientation sensor and the electronic display, the processor configured to:
determine an angle of the tool body relative to a reference plane based at least in part on the orientation data; and
present angle information pertaining to the angle via the electronic display.

2. The concrete forming tool of claim 1 wherein the angle information presented via the electronic display includes a visual indication of a direction of positive gradient or negative gradient.

3. The concrete forming tool of claim 2 wherein the visual indication includes an arrow indicating a direction of fluid flow on a surface at the angle.

4. The concrete forming tool of claim 1 wherein the angle information includes one or more of a slope, slope percent, pitch angle, and roll angle.

5. The concrete forming tool of claim 1 wherein the handle body includes a watertight compartment, wherein the orientation sensor and the processor are disposed in the watertight compartment.

6. The concrete forming tool of claim 5 further comprising a battery and charging circuitry disposed in the watertight compartment,
wherein the charging circuitry includes a secondary charging coil operable to charge the battery when the secondary charging coil is proximate to a primary charging coil of an inductive charger.

7. The concrete forming tool of claim 1 wherein the orientation sensor includes one or more of a gyroscope and an accelerometer.

8. The concrete forming tool of claim 1 further comprising a temperature sensor,
wherein to determine the angle of the tool body includes using an orientation detection algorithm,
wherein the processor is further configured to use temperature data of the temperature sensor to calibrate the orientation detection algorithm.

9. The concrete forming tool of claim 1 further comprising GNSS circuitry configured to perform RTK positioning, wherein the processor is operatively coupled to the GNSS circuitry and configured to determine an elevation of the handle body based at least in part on data of the GNSS circuitry.

10. The concrete forming tool of claim 1 further comprising a quick-attach mechanism to secure the handle body to the tool body and release the handle body from the tool body.

11. The concrete forming tool of claim 1 wherein the electronic display includes a display screen that is flush with an outer surface of the handle body.

12. The concrete forming tool of claim 1 wherein to determine an angle of the tool body includes to determine a pitch angle of a longitudinal axis of the tool body relative to the reference plane and a roll angle of a lateral axis of the tool body relative to the reference plane.

13. The concrete forming tool of claim 1 wherein the orientation sensor includes a first accelerometer and a second accelerometer, the first accelerometer and second accelerometer being mounted in the handle body such that a first accelerometer axis is opposite a second accelerometer axis,
wherein to determine an angle of the tool body includes determining the angle based at least in part on a differential of signals of the first accelerometer in the first accelerometer axis and the second accelerometer in the second accelerometer axis.

14. An electronic handle comprising:
a handle body;
a quick-attach mechanism having an actuator operable to releasably secure the handle body to a tool body;
an orientation sensor attached to the handle body and configured to output orientation data;
a processor operatively coupled to the orientation sensor and configured to determine an angle of the handle body relative to a reference plane based at least in part on the orientation data.

15. The electronic handle of claim 14 wherein the actuator is movable in a first direction to secure the handle body to the tool body and moveable in a second direction to release the handle body from the tool body.

16. The electronic handle of claim 14 wherein the actuator includes one or more of a knob and a lever.

17. The electronic handle of claim 14 wherein the quick-attach mechanism includes a first quick-attach mechanism at a first portion of the handle body and a second quick-attach mechanism at a second end of the handle body.

18. The electronic handle of claim 14 wherein the quick-attach mechanism includes a first magnetic component to interact with a second magnetic component of the tool body,
wherein the actuator is operable to move the first magnetic component toward the second magnetic component of the tool body to secure the handle body to the tool body and wherein the actuator is operable to move the first magnetic component away from the second magnetic component of the tool body to permit the handle body to be detached from the tool body.

19. The electronic handle of claim 18 wherein the first magnetic component includes one or more of a permanent magnet and a ferromagnetic body.

20. The electronic handle of claim 18 wherein the quick-attach mechanism includes a shaft attached to the first magnetic component, wherein the actuator includes a knob rotatable about an axis, wherein rotation of the knob causes the shaft and the first magnetic component to move axially toward or away from the tool body.

21. The electronic handle of claim 14 wherein the handle body is configured to mechanically interface with the tool body to inhibit the handle body from shifting laterally relative to the tool body when the handle body is secured to the tool body.

22. The electronic handle of claim 14 further comprising an attachment portion including the quick-attach mechanism, wherein the attachment portion includes a slot to receive a rail of the tool body,
wherein the quick-attach mechanism includes a brake to frictionally engage the rail of the tool body, the actuator operable to move the brake into or out of frictional engagement with the rail.

23. The electronic handle of claim 14 further comprising an electronic display operatively coupled to the processor, wherein the processor is configured to present angle information pertaining to the angle via the electronic display.

24. The electronic handle of claim 14 wherein the handle body includes a first portion secured to a second portion to form a watertight compartment housing the orientation sensor and the processor.
